(19) United States
(12) Patent Application Publication
(10) Pub. No.: US 2005/0253004 A1
(43) Pub. Date: Nov. 17, 2005

(54) Pedal-operated trashcan type paper shredder

(76) Inventors: Kuo-Chin Hsieh, Sin-Jhuang City (TW); Wei-Hsiung Hu, Sin-Jhuang City (TW); Yen-Ju Yang, Sin-Jhuang City (TW)

Correspondence Address: PRO-TECHTOR INTERNATIONAL SERVICES, 20775 Norada Court, Saratoga, CA, 95070-3018, US

(21) Appl. No.: 10/844,788

(22) Filed: May 12, 2004

(51) Int. Cl. B02C 18/22

(52) U.S. Cl. 241/100

(57) ABSTRACT

A pedal-operated trashcan type paper shredder includes a container, a cover with a narrow paper insertion slot pivoted to the container for closing/opening the container, a push bar vertically provided at one side of the container and adapted to move the cover between the open position and the close position, a pedal pivoted to the container for pressing by the user's foot to lift the push bar to open the cover from the container, and a paper-shredding unit mounted inside the cover corresponding to the paper insertion slot for shredding paper into pieces.

### BACKGROUND OF THE INVENTION

1. Field of the Invention

The present invention relates generally to a paper shredder and more particularly, to a pedal-operated trashcan type paper shredder that can be used as a trashcan as well as a paper shredder.

2. Description of the Related Art

When cut waste paper into small pieces through a conventional paper shredder, these small pieces must be thrown into a trashcan. In order to eliminate this complicated operation procedure, combinations of paper shredder and trashcan were developed. FIG. 1 shows a combination of paper shredder and trashcan according to the prior art. According to this design, the combination of paper shredder and trashcan comprises a trashcan 2, and a paper shredder 1 mounted on the top of the trashcan 2. This combination of paper shredder and trashcan produces much noise during operation. Further, the user needs to remove the paper shredder 1 from the trashcan 2 when disposing of waste material.

### SUMMARY OF THE INVENTION

The present invention has been accomplished under the circumstances in view. It is the main object of the present invention to provide a pedal-operated trashcan type paper shredder, which is convenient for use as a paper shredder as well as a trashcan.

To achieve this and other objects of the present invention, the pedal-operated trashcan type paper shredder comprises a container; a cover pivoted to the container and adapted to close/open the container, the cover having a narrow elongated paper insertion slot for insertion of waste paper into the container; a push bar vertically provided at one side of the container and adapted to move the cover between two positions to open/close the container; a pedal pivoted to a bottom side of the container and coupled to a bottom end of the push bar for pressing by the user's foot to lift the push bar to open the cover from the container; and a paper-shredding unit mounted inside the cover corresponding to the paper insertion slot for shredding paper into pieces. Further, the push bar comprises a triangular rib disposed at the back side thereof, and the container comprises two serrated rubber blocks mounted on the outside and meshed with the triangular rib at two opposite sides for smoothening vertical movement of the push bar.

### BRIEF DESCRIPTION OF THE DRAWINGS

FIG. 1 is an elevational view of a combination of paper shredder and trashcan according to the prior art.

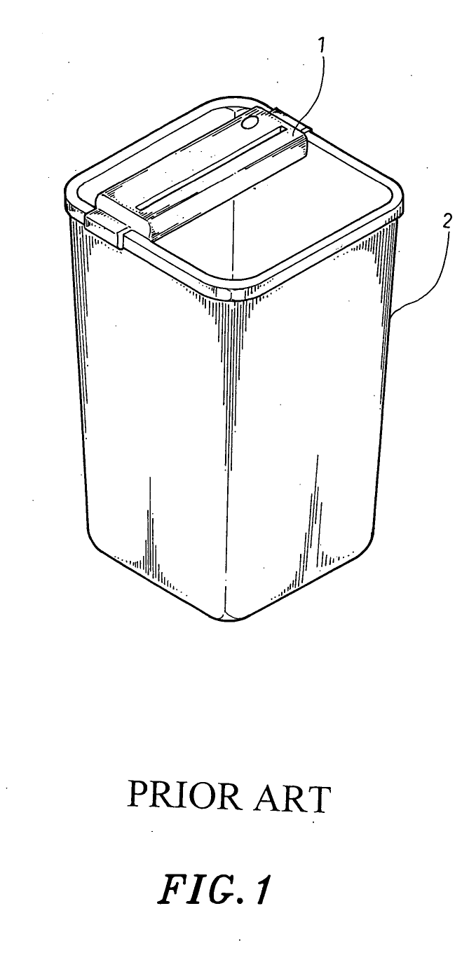

FIG. 2 is an elevational view of a pedal-operated trashcan type paper shredder according to the present invention.

FIG. 3 is an exploded view of the pedal-operated trashcan type paper shredder according to the present invention.

FIG. 4 is a schematic perspective view showing the installation of the paper shredder in the trashcan according to the present invention.

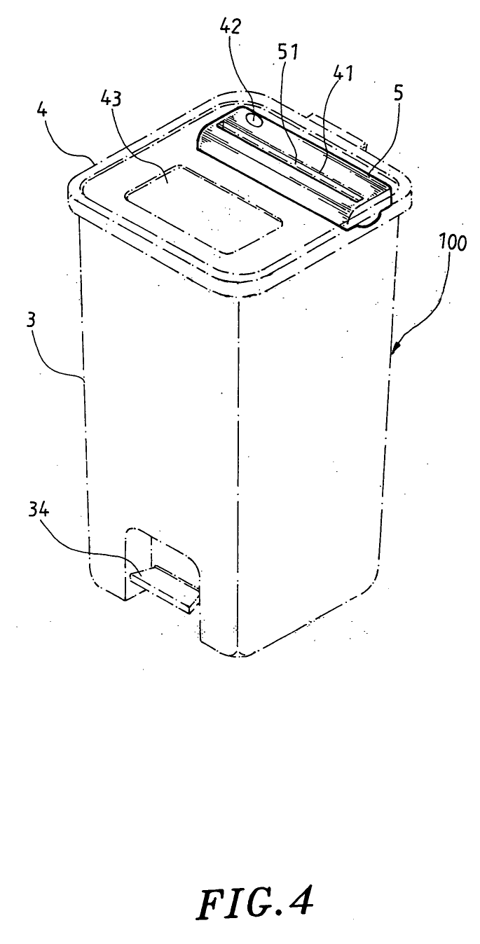

FIG. 5 is a schematic drawing showing the action of the pedal-operated trashcan type paper shredder according to the present invention (I).

FIG. 6 is a schematic drawing showing the action of the pedal-operated trashcan type paper shredder according to the present invention (II).

FIG. 7 is an enlarged view of a part of the present invention, showing the serrated rubber blocks meshed with the triangular rib of the push bar.

### DETAILED DESCRIPTION OF THE INVENTION

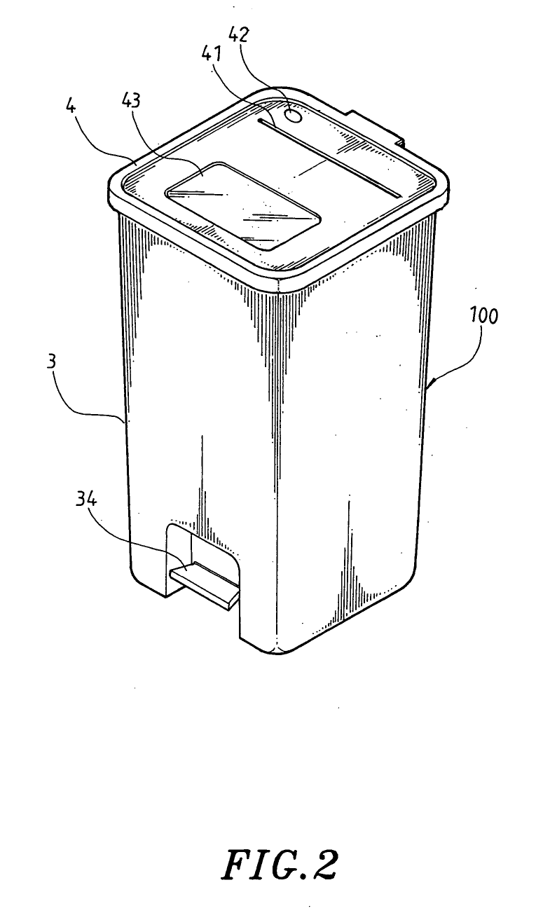

Referring to FIGS. 2˜4, a pedal-operated trashcan type paper shredder 100 is shown comprising a container 3, a cover 4, and a paper-shredding unit 5.

The container 3 comprises a pivot holder 31 disposed at the back side of the top opening thereof. The cover 4 is peripherally packed with a rubber packing member 40 and pivoted to the pivot holder 31 for covering the top opening of the container 3. The container 3 comprises a sliding groove 32 vertically disposed at the back side, a push bar 33 axially slidably mounted in the sliding groove 32, a pedal 34 pivoted to the bottom end of the sliding groove 32 and coupled to the bottom end of the push bar 33 for operation by the user's foot to force the push bar 33 to open the cover 4 from the container 3. Two serrated rubber blocks 36 are respectively fastened to two mounting holes 35 at two opposite lateral sides of the sliding groove 32, and meshed with a triangular rib 331 at the back side of the push bar 33 for smoothening vertical movement of the push bar 33 in the sliding groove 32.

The paper-shredding unit 5 is provided at the bottom side of the cover 4. The cover 4 comprises a narrow elongated insertion slot 41 aimed at the inlet 51 of the paper-shredding unit 5, a view window 42 through which the user can see the inside of the container 3, and a power switch 42 electrically connected to the paper-shredding unit 5 for controlling the operation of the paper-shredding unit 5.

When in use, switch on the power switch 42, and then insert waster paper through the insertion slot 41 into the inlet 51 of the paper-shredding unit 5 for cutting into pieces. The cut pieces of waste paper immediately fall out of the outlet 52 of the paper-shredding unit 5 to the inside of the container 3. When wishing to throw garbage into the container 3, press the pedal 34 with the foot to lift the push bar 33 to open the cover 4 from the container 3. Further, a switch control rod 37 is provided inside the container 3 near the top. When the cover 4 is closed on the container 3, the switch control rod 37 is pressed on a micro switch (not shown) in the shredding unit 5 to switch on the power circuit of the paper-shredding unit 5. When opened the cover 4, the micro switch of the shredding unit 5 is released from the switch control to switch off the power circuit, preventing a contact accident.

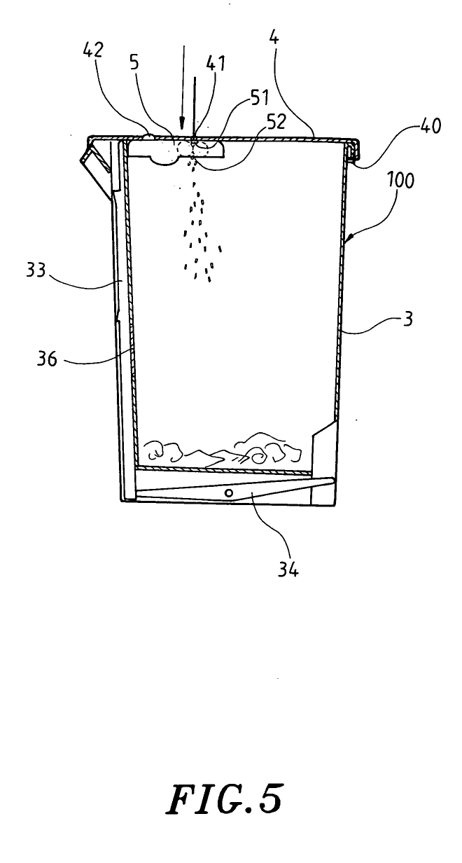

Referring to FIG. 5, when using the paper-shredding unit 5, the cover 4 is closed on the container 3, waste paper 6 is inserted through the insertion slot 41 into the inlet 51 of the paper-shredding unit 5 and then cut by the paper-shredding unit 5 into pieces that fall out of the outlet 52 of the paper-shredding unit 5 to the inside of the container 3. Because the paper-shredding unit 5 is suspended in the enclosed space defined by the container 3 and the cover 4, the operation of the paper-shredding unit 5 does not cause much noise.

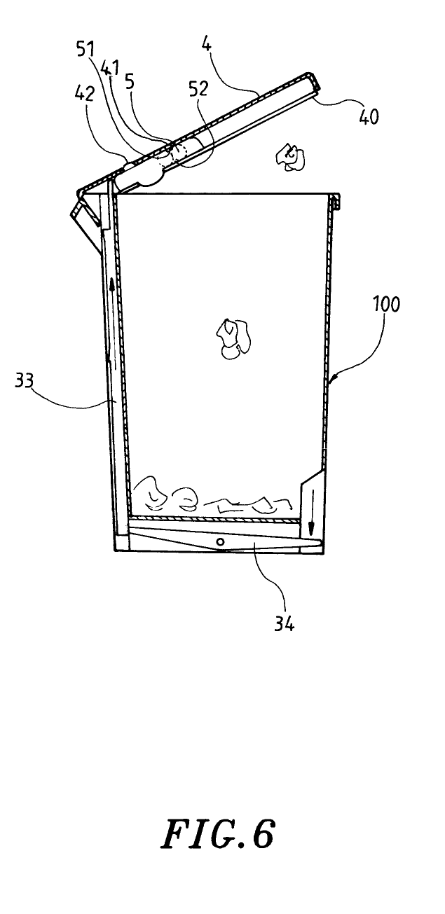

When throwing garbage, press the pedal 34 with the foot to lift the push bar 33 to open the cover 4 from the container 3 (see FIG. 6), thus garbage can be directly thrown into the container 3. Further, through the view window 43, the user can seed the amount of waste matter in the container 3.

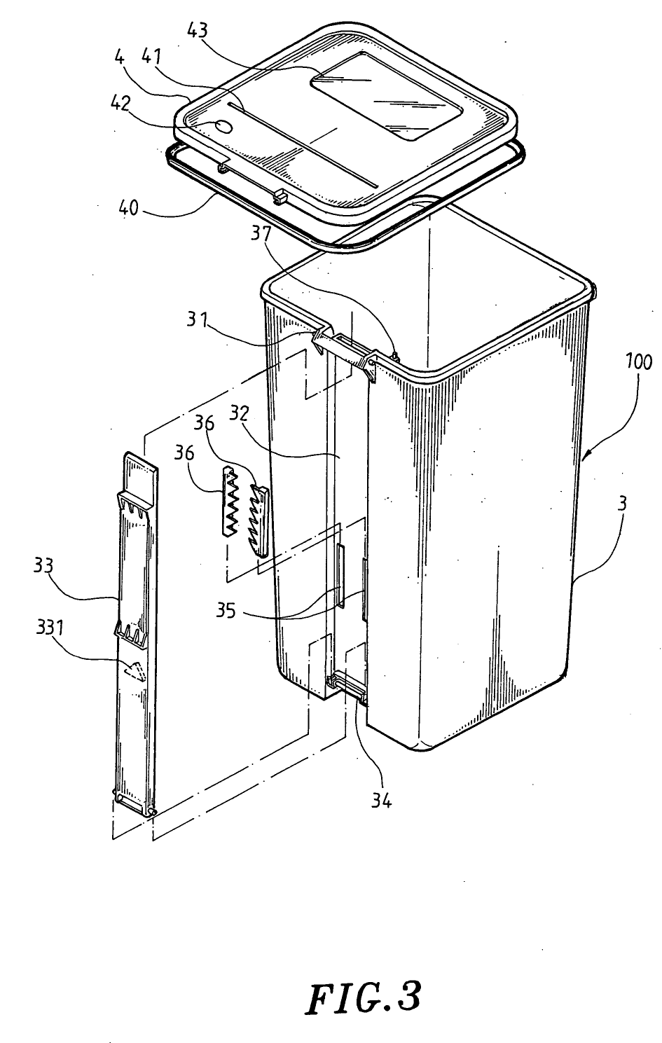

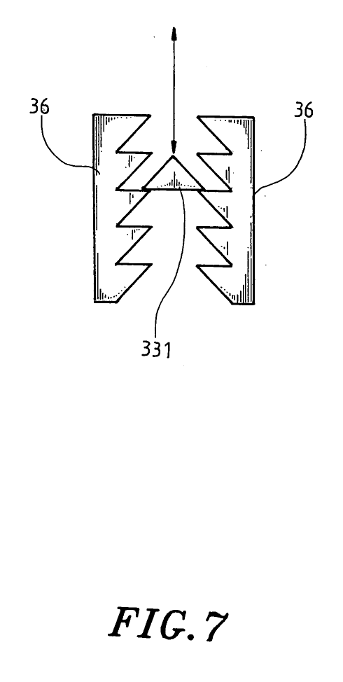

Referring to FIG. 7 and FIG. 3 again, because the serrated rubber blocks 36 are meshed with a triangular rib 331 of the push bar 33 at two sides, moving the push bar 33 in the sliding groove 32 forces the triangular rib 331 over the serrated rubber blocks 36 to smoothen vertical movement of the push bar 33 in the sliding groove 32. Therefore, the push bar 33 is lowered smoothly after the user released the foot from the pedal 34, preventing a sudden falling of the cover 4 on the container 3 to damage the shredding unit 5.

A prototype of pedal-operated trashcan type paper shredder has been constructed with the features of FIGS. 2˜7. The pedal-operated trashcan type paper shredder functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. A pedal-operated trashcan type paper shredder comprising:
a container;
a cover pivoted to said container and adapted to close/open said container, said cover having a narrow elongated paper insertion slot for insertion of waste paper into said container;
a push bar vertically provided at one side of said container and adapted to move said cover between two positions to open/close said container;
a pedal pivoted to a bottom side of said container and coupled to a bottom end of said push bar for pressing by the user's foot to lift said push bar to open said cover from said container; and
a paper-shredding unit mounted inside said cover corresponding to said paper insertion slot for shredding paper into pieces.

2. The pedal-operated trashcan type paper shredder as claimed in claim 1, wherein said push bar comprises a triangular rib disposed at a back side thereof; said container comprises two serrated rubber blocks mounted in an outside wall thereof and meshed with said triangular rib at two opposite sides for smoothening vertical movement of said push bar.

3. The pedal-operated trashcan type paper shredder as claimed in claim 1, wherein said cover is peripherally packed with a rubber packing member.

4. The pedal-operated trashcan type paper shredder as claimed in claim 1, wherein said container comprises an upwardly extended switch control rod adapted to switch on/off power circuit means of said paper-shredding unit subject to close/open status of said cover.
